(19) United States
(12) Patent Application Publication
(10) Pub. No.: US 2015/0293469 A1
(43) Pub. Date: Oct. 15, 2015

(54) Roll Having Textured Axial Ends to Prevent Toner Leakage

(71) Applicant: Lexmark International, Inc., Lexington, KY (US)

(72) Inventors: Marc Frazier Baker, Georgetown, KY (US); Kyle Benjamin Freels, Georgetown, KY (US); Robert Francis Soto, Lexington, KY (US); Donald Wayne Stafford, Lexington, KY (US)

(73) Assignee: Lexmark International, Inc., Lexington, KY (US)

(21) Appl. No.: 14/249,578

(22) Filed: Apr. 10, 2014

(51) Int. Cl. G03G 15/08

(52) U.S. Cl. CPC G03G 15/0808

(57) ABSTRACT

A roll for use in an electrophotographic image forming device according to one example embodiment includes a shaft defining an axis of rotation of the roll. The roll includes an outer circumferential surface having a pair of axial ends. Recessed grooves and/or raised ribs are present in the outer circumferential surface near the axial ends. The recessed grooves and/or raised ribs are angled relative to the axis of rotation of the roll away from a direction of rotation of the roll from the axial ends inward or parallel to the axis of rotation of the roll to direct toner away from the axial ends.

### CROSS REFERENCES TO RELATED APPLICATIONS

None.

### BACKGROUND

1. Field of the Disclosure

The present disclosure relates generally to image forming devices and more particularly to a roll having textured axial ends to prevent toner leakage.

2. Description of the Related Art

Various methods are used in electrophotographic image forming devices to prevent toner leakage. For example, toner leakage may occur from the gaps between a developer roll that supplies toner to a photoconductive drum of the electrophotographic printer, a doctor blade in contact with the developer roll and the housing of a replaceable unit that holds the developer roll and the doctor blade. Toner leakage may also occur from gaps between a toner adder roll that supplies toner to the developer roll and the housing of the replaceable unit that holds the toner adder roll and developer roll. Seals may be used to close the gaps between these components to prevent toner leakage. However, as printing speeds increase and the intended lifespans of replaceable units for image forming devices increase, the risk of toner leakage is compounded. Leaked toner may fall into the image forming device or onto surfaces surrounding the image forming device, such as a desktop or a user's clothing, resulting in uncleanliness. Further, when leaked toner falls into the internal portions of the image forming device, it can cause reliability issues and, in some cases, print defects. Accordingly, additional measures to prevent toner leakage are desired.

### SUMMARY

A roll for use in an electrophotographic image forming device according to one example embodiment includes a shaft defining an axis of rotation of the roll. The roll includes an outer circumferential surface having a pair of axial ends. Recessed grooves and/or raised ribs are present in the outer circumferential surface near the axial ends. The recessed grooves and/or raised ribs are angled relative to the axis of rotation of the roll away from a direction of rotation of the roll from the axial ends inward or parallel to the axis of rotation of the roll to direct toner away from the axial ends.

A developer unit for an electrophotographic image forming device according to one example embodiment includes a developer roll having a shaft defining an axis of rotation of the developer roll and an outer circumferential surface having a pair of axial ends. A pair of seals is positioned at opposite axial ends of the developer roll against respective portions of the outer circumferential surface of the developer roll. The portions of the outer circumferential surface of the developer roll positioned against the pair of seals include at least one of recessed grooves and raised ribs that are angled relative to the axis of rotation of the developer roll or parallel to the axis of rotation of the developer roll to direct toner away from the axial ends during rotation of the developer roll.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a schematic view of an electrophotographic image forming device according to one example embodiment.

FIG. 2 is a perspective view of a portion of a developer unit of an electrophotographic image forming device according to one example embodiment.

FIG. 3 is a perspective view of the developer unit shown in FIG. 2 with a developer roll and a doctor blade removed to show a sealing member according to one example embodiment.

FIG. 4 is a sectional side view of the developer unit shown in FIGS. 2 and 3.

FIG. 5 includes front and rear perspective views of the sealing member shown in FIGS. 3 and 4.

FIG. 6 is a top plan view of the developer roll of FIG. 2 having recessed grooves according to a first example embodiment.

FIG. 7 is a top plan view of the developer roll of FIG. 2 having recessed grooves according to a second example embodiment.

FIG. 8 is a top plan view of the developer roll of FIG. 2 having raised ribs according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

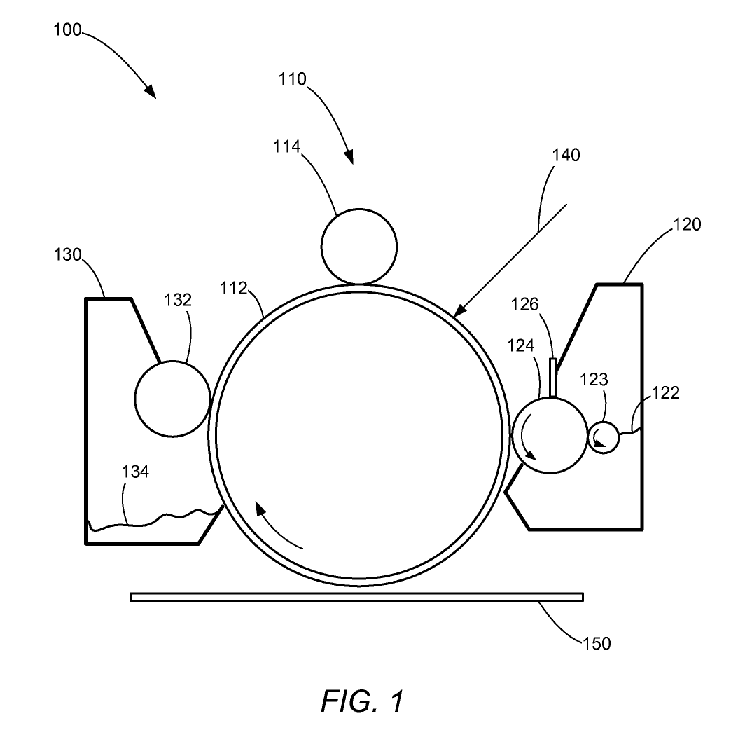

Referring now to the drawings and particularly to FIG. 1, an electrophotographic image forming device 100 is shown schematically according to one example embodiment. The electrophotographic printing process is well known in the art and, therefore, is described briefly. During a print operation, a charge roll 114 charges the surface of a photoconductive drum 112 to a predetermined voltage. Charge roller 114 and photoconductive drum 112 together form a photoconductor unit 110. The charged surface of photoconductive drum 112 is then selectively exposed to a laser light source 140 to selectively discharge the surface of photoconductive drum 112 and form an electrostatic latent image on photoconductive drum 112 corresponding to the image being printed. Charged toner from a developer unit 120 is picked up by the latent image on photoconductive drum 112 creating a toned image.

Developer unit 120 includes a toner sump 122 having toner particles stored therein. A toner adder roller 123 and a developer roller 124 are mounted in toner sump 122. Toner adder roller 123 moves toner stored in toner sump 122 to developer roller 124. Developer roller 124 is electrically charged and electrostatically attracts the toner particles supplied by toner adder roller 123. In one embodiment, toner adder roller 123 and developer roller 124 rotate in the same rotational direction such that their adjacent surfaces move in opposite directions to charge the toner transferred from the toner adder roller 123 to developer roller 124. A doctor blade 126 positioned along developer roller 124 provides a substantially uniform layer of toner on developer roller 124. As developer roller 124 and photoconductive drum 112 rotate, toner particles are electrostatically transferred from developer roller 124 to the latent image on photoconductive drum 112 forming a toned image on the surface of photoconductive drum 112. In one embodiment, developer roller 124 and photoconductive drum 112 rotate in opposite rotational directions such that their adjacent surfaces move in the same direction to facilitate the transfer of toner from developer roller 124 to photoconductive drum 112.

The toned image is then transferred from photoconductive drum 112 to print media 150 (e.g., paper) either directly by photoconductive drum 112 or indirectly by an intermediate transfer member. A fusing unit (not shown) fuses the toner to print media 150. A cleaning roller 132 (or cleaning blade) of a cleaner unit 130 removes any residual toner adhering to photoconductive drum 112 after the toner is transferred to print media 150. Waste toner removed by cleaning roller 132 is held in a waste toner sump 134 in cleaner unit 130. The cleaned surface of photoconductive drum 112 is then ready to be charged again and exposed to laser light source 140 to continue the printing cycle.

The components of image forming device 100 are replaceable as desired. For example, in one embodiment, photoconductor unit 110, developer unit 120 and cleaner unit 130 are housed in a replaceable unit with the main toner supply of image forming device 100. In another embodiment, photoconductor unit 110, developer unit 120 and cleaner unit 130 are provided in a first replaceable unit while the main toner supply of image forming device 100 is housed in a second replaceable unit. In another embodiment, developer unit 120 is provided with the main toner supply of image forming device 100 in a first replaceable unit and photoconductor unit 110 and cleaner unit 130 are provided in a second replaceable unit. It will be appreciated that any other combination of replaceable units may be used as desired. Further, in the case of an image forming device configured to print in color, separate replaceable units may be used for each toner color. For example, in one embodiment, the image forming device includes four photoconductor units 110, developer units 120 and cleaner units 130, each corresponding to a particular toner color (e.g., black, cyan, yellow and magenta) and each replaceable as discussed above.

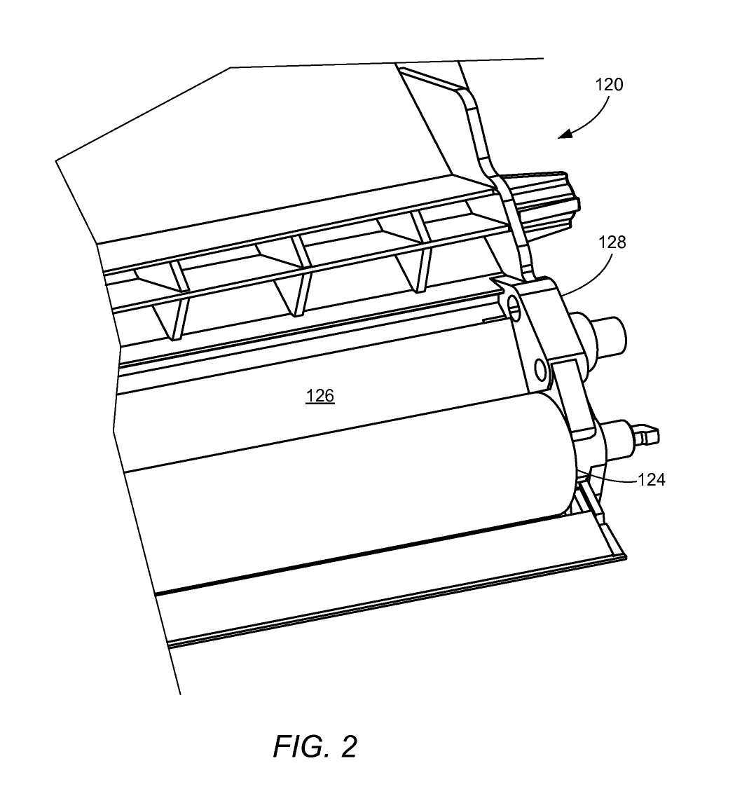

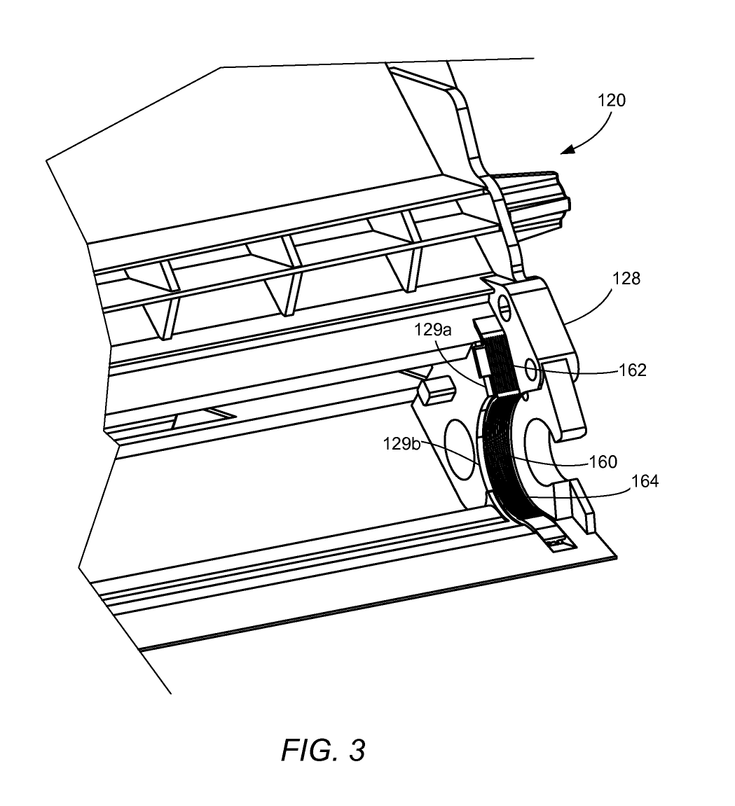

FIG. 2 illustrates an example developer unit 120 including a housing 128 containing developer roll 124 and doctor blade 126 positioned against developer roll 124. FIG. 3 shows developer unit 120 with developer roll 124 and doctor blade 126 removed to more clearly illustrate the internal components of developer unit 120. FIG. 3 shows an example sealing member 160 positioned in housing 128 at one axial end of developer roll 124. A second sealing member (not shown) is positioned at the opposite axial end of developer roll 124 and may be substantially the same as sealing member 160. A blade seal portion 162 of sealing member 160 is compressed between an interface 129a formed in housing 128 and an end portion of doctor blade 126 (FIG. 2). A rotary seal portion 164 of sealing member 160 is compressed between a curved interface 129b formed in housing 120 and an axial end portion of developer roll 124 (FIG. 2). FIG. 4 shows a side view of sealing member 160 in housing 128 positioned against developer roll 124 and doctor blade 126. As shown in FIG. 4, blade seal portion 162 of sealing member 160 is positioned against a rear surface of doctor blade 126 and rotary seal portion 164 of sealing member 160 is curved around and positioned against a rear surface of developer roll 124. Sealing member 160 may be described as J-shaped due to its substantially straight blade seal portion 162 and connecting curved rotary seal portion 164. Sealing member 160 prevents toner from leaking at the axial ends of developer roll 124 at the interface between housing 128, developer roll 124 and doctor blade 126.

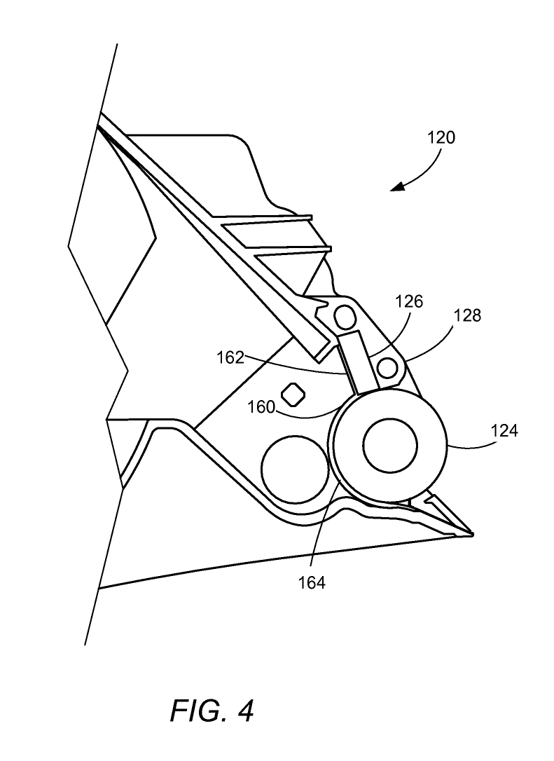

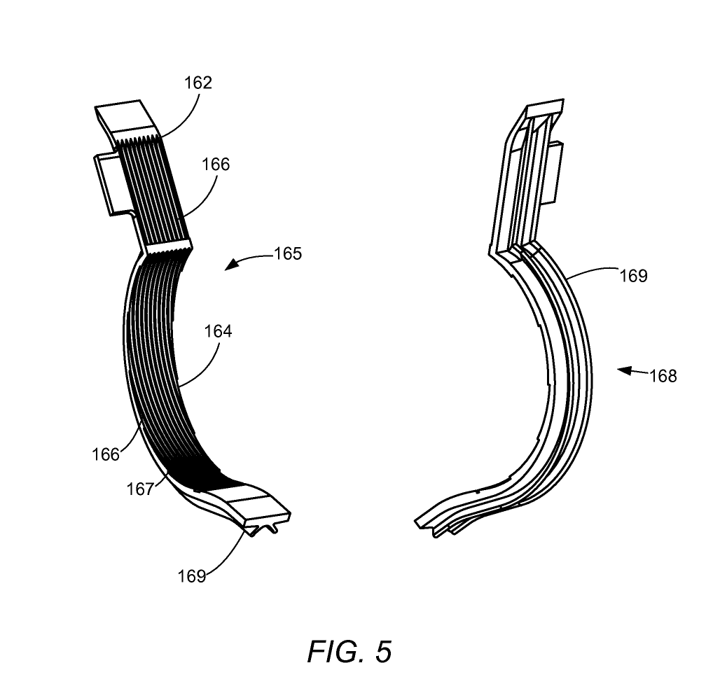

FIG. 5 shows an example sealing member 160 in more detail. In this embodiment, a sealing face 165 of sealing member 160 includes grooves 166 therein formed between ribs 167 to prevent the migration of toner past sealing member 160. Grooves 166 on sealing face 165 of rotary seal portion 164 are angled to guide toner away from the axial end of developer roll 124 during rotation of developer roil 124. In the example embodiment illustrated, a rear face 168 of sealing member 160 includes one or more biasing ribs 169 which may run along all or a portion of rear face 168. Biasing ribs 169 bias sealing face 165 against doctor blade 126 and developer roll 124 to prevent toner leaks. Of course sealing member 160 may be any suitable shape as desired such as with or without grooves 166 and/or ribs 169. In one embodiment, sealing member 160 includes a molded (e.g., injection molded or compression molded) body made of a polymeric elastomeric material such as SANTOPRENE™, a thermoplastic vulcanizate available from Exxon Mobil Corporation.

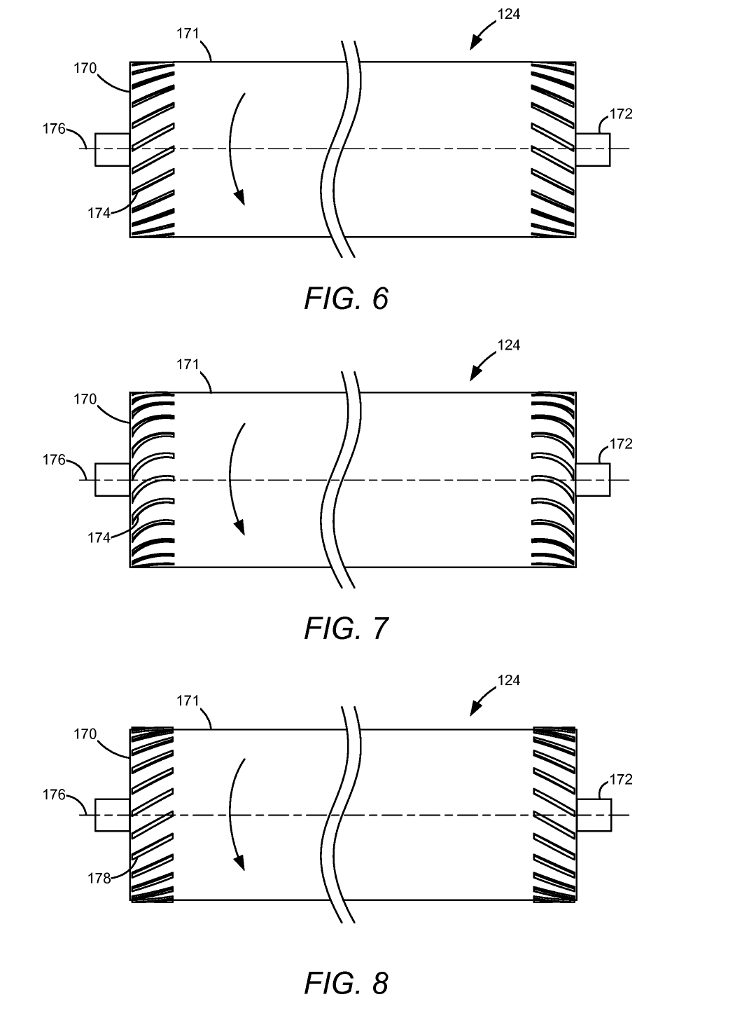

FIG. 6 shows an example developer roll 124 in more detail. Developer roll 124 includes a roll core 170 mounted (e.g., molded) on a shaft 172. Shaft 172 may be electrically conductive or non-conductive. Conductive material may include metal such as aluminum, aluminum stainless steel, iron, nickel, copper, etc. Polymeric materials for shaft 104 may include polyamide, polyetherimide, etc.

Core 170 may be made of a thermoplastic or thermoset elastomeric type material. The elastomeric material may substantially recover (e.g., >75%) after an applied stress (e.g., a compression type force). The elastomeric material may be any suitable material that provides the ability for developer roll 124 to elastically deform at a given nip location in the image forming device while also providing some level of nip pressure. For example, core 170 may include an electrically conductive or semi-conductive soft rubber. The soft rubber may include, for example, silicone rubber, nitrile rubber, ethylene propylene copolymers, polybutadiene, styrene-co-butadiene, isoprene rubber, polyurethane, or a blend or copolymer of any of these rubbers. In one embodiment, core 170 is comprised of a polyurethane elastomer including an isocyanate portion and a polyol portion. The isocyanate portion may include, for example, toluene diisocyanate (TDI), polymeric TDI, diphenylmethane diisocyanate (MDI), polymeric MDI, dicyclohexylmethane diisocyanate (H₁₂MDI), polymeric H₁₂MDI, isophorone diisocyanate (IPDI), polymeric IPDI, 1,6-hexamethytene diisocyanate (HDI), polymeric HDI, etc. The polyol portion may include, for example, a polyether, polyester, polybutadiene, polydimethylsiloxane, etc. having two or more reactive hydroxyl groups or mixtures thereof. The conductivity of core 170 may be supplied by one or more ionic additives, inherently conductive polymers, carbon black, carbon nanoparticles, carbon fibers, graphite, etc. The ionic additives may include, for example, LiPF₆, LiAsF₆, LiClO₄, LiBF₄, LiCF₃SO₃, LiN(SO₂CF₃)₂, LiC(SO₂CF₃)₃, LiPF₃(C₂F₅), Cs(CF₃COCH₂COCF₃) (abbreviated as CsHFAc), KPF₆, NaPF₆, CuCl₂, FeCl₃, FeCl₂, Bu₄NPF₆, Bu₄NSO₃CF₃, Bu₄NCl, Bu₄NBr or dimethylethyldodecylammonium ethosulfate. The inherently conductive polymer(s) may include, for example, polyaniline, poly(3-alkylthiophenes), poly(p-phenylenes), or poly(acetylenes).

Once core 170 is formed, a finishing operation, such as mechanical grinding, may be applied to an outer surface 171 of core 170 in order to achieve a desired surface roughness for optimal toner transfer and charging. Developer roll 124 may also include a coating on outer surface 171 of core 170. For example, the coating may include an electrically conductive material in order to tune the electrical resistivity of the outer surface of developer roll 124 with respect to core 170. For example, the coating may include polyurethane and a conductive additive. The isocyanate portion and the polyol portion of the polyurethane may include any of the materials discussed above with respect to core 170. Additional curatives such as atmospheric moisture or polyamines may be used in conjunction with or as a replacement for the polyol portion of the polyurethane. In this embodiment, polyamines may include, for example, small molecule or polymer structures such as polyethers having two or more reactive amine groups. Further, the conductive additive may include any of the additives discussed above with respect to core 170. The coating may also include additional fillers such as, for example, silica to control rheological properties. The coating may be applied by any conventional method known in the art such as, for example, dip or spray coating.

Developer roll 124 includes recessed grooves 174 on outer surface 171 of core 170. Grooves 174 are positioned near the axial ends of core 170 axially outward from the portion of developer roll 124 that transfers toner to photoconductive drum 112. For example, grooves 174 may be positioned axially outward from the width of the widest printed image supported by image forming device 100. In one embodiment, grooves 174 are spaced axially inward from the axial ends of core 170 by, for example, about 0.5 mm to about 4 mm including all values and increments therebetween. In one embodiment, grooves 174 are angled relative to an axis of rotation 176 of shaft 172 away from the direction of rotation of developer roll 124 from the axial ends of core 170 inward (as shown in FIG. 6) in order to channel toner away from the axial ends of developer roll 124 during rotation of developer roll 124. In another embodiment, grooves 174 are substantially parallel to axis of rotation 176 of shaft 172. For example, grooves 174 may be angled between 0 degrees and about 80 degrees relative to axis of rotation 176 of shaft 172 away from the direction of rotation of developer roll 124 from the axial ends of core 170 inward including all values and increments therebetween such as, for example, between about 10 degrees and about 80 degrees, between about 15 degrees and about 70 degrees, etc. Grooves 174 direct residual toner on developer roll 124 toward toner sump 122 and away from the interface between developer roll 124 and housing 128 where toner may be able to leak out of housing 128. Where developer unit 120 includes sealing members 160 having grooves 166, grooves 174 of developer roll 124 work in conjunction with grooves 166 of sealing members 160 at each axial end of developer roll 124 to direct toner away from the axial ends of developer roll 124 to prevent toner leakage.

In one embodiment, the width of each groove 174 is between about 0.1 mm and about 0.3 mm including all values and increments therebetween and the depth of each groove 174 is between about 0.03 mm and about 0.05 mm including all values and increments therebetween. In one embodiment, each groove 174 has a substantially constant width and depth; however, the width and/or depth of each groove 174 may vary as desired. In one embodiment, each axial end of core 170 includes at least twelve grooves 174 circumferentially spaced around outer surface 171 of core 170 and may include up to twenty-four grooves 174 or more. In the example embodiment illustrated, grooves 174 are substantially equally spaced circumferentially; however, the circumferential spacing between grooves 174 may be varied as desired. In one embodiment, portions of grooves 174 may be interconnected.

In the example embodiment illustrated in FIG. 6, each groove 174 is angled by the same amount relative to axis of rotation 176 of shaft 172. In another embodiment, the angles of grooves 174 at each axial end of core 170 relative to axis of rotation 176 vary. In the example embodiment illustrated in FIG. 6, each groove 174 is formed as a substantially straight line segment across outer surface 171 of core 170. In another embodiment shown in FIG. 7, grooves 174 are formed as curved segments across outer surface 171 of core 170 that vary in angle relative to axis of rotation 176. Alternatively, each groove 174 may be formed as multiple straight line segments angled relative to each other or a combination of curved and straight line segments as desired. In one embodiment, the shape of each groove 174 is substantially constant in the radial direction with respect to core 170; however, in other embodiments each groove 174 may have a varying three-dimensional profile such that the shape of each groove 174 may vary in the radial direction or each groove 174 may be angled or curved relative to the radial direction of core 170.

Grooves 174 may be formed in core 170, for example, by mechanical grinding or cutting. In another embodiment, grooves 174 are formed in core by laser cutting using any suitable laser cutting device such as, for example, a CO₂ laser or an excimer laser. Grooves 174 may also be formed by the targeted application of heat to outer surface 171 of core 170. Alternatively, grooves 174 are etched into outer surface 171 of core 170 using a temporary photoresist mask or a physical mask in the form of a sleeve that wraps around outer surface 171 of core 170 with openings to expose the locations where grooves 174 are desired. Where outer surface 171 of core 170 undergoes a finishing operation and/or a coating is applied to outer surface 171 of core, grooves 174 may be formed after completing the finishing operation and applying the coating. Grooves 174 may also be molded into core 170; however, this method is not preferred where a coating is applied to outer surface 171 of core 170 because the coating may tend to fill grooves 174.

With reference to FIG. 8, in another embodiment, outer surface 171 of core 170 includes raised ribs 178 instead of recessed grooves 174. Ribs 178 may be positioned and angled in the same manner discussed above for grooves 174. The dimensions and shapes of ribs 178 may be the same as those discussed above for grooves 174 except that the height of each rib 178 may be between about 0.03 mm and about 0.05 mm including all values and increments therebetween. Ribs 178, like grooves 174, direct residual toner on developer roll 124 toward toner sump 122 and away from the axial ends of core 170 during rotation of developer roll 124. In one embodiment, recessed grooves 174 and raised ribs 178 are used in combination at the axial ends of outer surface 171 of core 170.

Ribs 178 may be molded onto outer surface 171 of core 170. Ribs 178 may also be printed onto outer surface 171 of core 170 using a jettable material that adheres to outer surface 171 of core 170 or the coating applied to outer surface 171 of core 170. For example, ribs 178 may be printed using thermal printing, piezoelectric printing or a dispensing pump.

The example embodiments discussed above include a developer roll 124 having grooves 174 and/or ribs 178 on its outer surface. However, other rolls of image forming device 100 may utilize grooves or ribs near their axial ends to direct toner away from the axial ends of such components to prevent toner leakage. For example, toner adder roll 123 may include grooves 174 or ribs 178 on its outer surface near its axial ends. Similarly, developer rolls having a different construction than those discussed herein may also utilize grooves and/or ribs on their outer surfaces.

The foregoing description illustrates various aspects of the present disclosure, it is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A roll for use in an electrophotographic image forming device, comprising:
a shaft defining an axis of rotation of the roll;
an outer circumferential surface having a pair of axial ends; and
recessed grooves in the outer circumferential surface near the axial ends, the recessed grooves are angled relative to the axis of rotation of the roll away from a direction of rotation of the roll from the axial ends inward or parallel to the axis of rotation of the roll to direct toner away from the axial ends.

2. The roll of claim 1, wherein the roll is a developer roll having an elastomeric core mounted on the shaft and the recessed grooves are in an outer circumferential surface of the elastomeric core.

3. The roll of claim 1, wherein the recess grooves are angled relative to the axis of rotation of the roll away from the direction of rotation of the roll from the axial ends inward.

4. The roll of claim 3, wherein the recessed grooves are angled between about 10 degrees and about 80 degrees relative to the axis of rotation of the roll away from the direction of rotation of the roll from the axial ends inward.

5. The roll of claim 1, wherein a width of each groove is between about 0.1 mm and about 0.3 mm.

6. The roll of claim 1, wherein a depth of each groove is between about 0.03 mm and about 0.05 mm.

7. The roll of claim 1, wherein each axial end of the outer circumferential surface includes at least twelve recessed grooves circumferentially spaced around the outer circumferential surface.

8. The roll of claim 1, wherein the recessed grooves at each axial end of the outer circumferential surface are circumferentially spaced substantially equally from each other.

9. The roll of claim 1, wherein each recessed groove forms a substantially straight line segment across a portion of the outer circumferential surface.

10. A roll for use in an electrophotographic image forming device, comprising:
a shaft defining an axis of rotation of the roll;
an outer circumferential surface having a pair of axial ends; and
raised ribs on the outer circumferential surface near the axial ends, the raised ribs are angled relative to the axis of rotation of the roll away from a direction of rotation of the roll from the axial ends inward or parallel to the axis of rotation of the roll to direct toner away from the axial ends.

11. The roll of claim 10, wherein the roll is a developer roll having an elastomeric core mounted on the shaft and the raised ribs are on an outer circumferential surface of the elastomeric core.

12. The roll of claim 10, wherein the raised ribs are angled relative to the axis of rotation of the roll away from the direction of rotation of the roll from the axial ends inward.

13. The roll of claim 12, wherein the raised ribs are angled between about 10 degrees and about 80 degrees relative to the axis of rotation of the roll away from the direction of rotation of the roll from the axial ends inward.

14. The roll of claim 10, wherein a width of each rib is between about 0.1 mm and about 0.3 mm.

15. The roll of claim 10, wherein a height of each rib is between about 0.03 mm and about 0.05 mm.

16. The roll of claim 10, wherein each axial end of the outer circumferential surface includes at least twelve raised ribs circumferentially spaced around the outer circumferential surface.

17. The roll of claim 10, wherein the raised ribs at each axial end of the outer circumferential surface are circumferentially spaced substantially equally from each other.

18. The roll of claim 10, wherein each raised rib forms a substantially straight line segment across a portion of the outer circumferential surface.

19. A developer unit for an electrophotographic image forming device, comprising:
a developer roll having a shaft defining an axis of rotation of the developer roll and an outer circumferential surface having a pair of axial ends; and
a pair of seals positioned at opposite axial ends of the developer roll against respective portions of the outer circumferential surface of the developer roll,
wherein the portions of the outer circumferential surface of the developer roll positioned against the pair of seals include at least one of recessed grooves and raised ribs that are angled relative to the axis of rotation of the developer roll or parallel to the axis of rotation of the developer roll to direct toner away from the axial ends during rotation of the developer roll.

20. The developer unit of claim 19, wherein said at least one of recessed grooves and raised ribs are angled between about 10 degrees and about 80 degrees relative to the axis of rotation of the developer roll away from a direction of rotation of the developer roll from the axial ends inward.
